(19) United States
(12) Patent Application Publication
(10) Pub. No.: US 2009/0144536 A1
(43) Pub. Date: Jun. 4, 2009

(54) Monitoring method and monitor apparatus

(75) Inventor: Yu-chi Chen, Taipei Hsien (TW)

Correspondence Address: BACON & THOMAS, PLLC, 625 SLATERS LANE, FOURTH FLOOR, ALEXANDRIA, VA, 22314-1176, US

(73) Assignee: Wistron Corporation, Taipei Hsien (TW)

(21) Appl. No.: 12/232,558

(22) Filed: Sep. 19, 2008

(30) Foreign Application Priority Data
Dec. 3, 2007 (TW) 096145974

(51) Int. Cl. G06F 15/177

(52) U.S. Cl. 713/2

(57) ABSTRACT

A monitoring method and a monitor apparatus thereof are disclosed. The monitor apparatus is used to monitor an USB port of a computer. The monitor apparatus comprises an input/output control unit and a basic input/output system code storage unit. The basic input/output system code storage unit is used to store a basic input/output system code. A monitor method comprises following steps: executing the basic input/output system code; determining whether the USB port connects with a USB device or not; if the USB port connects with a USB device, reading out an identification of the USB device; determining whether the identification is a certified identification or not; and executing a correspondingly process if the identification is not a certified identification.

### BACKGROUND OF THE INVENTION

1. Field of the Invention

The present invention relates to a monitor apparatus and, more particularly, to a monitor apparatus for monitoring a USB port.

2. Description of the Related Art

With technology improvement, there are more and more periphery apparatuses can be connected to computer systems, and the computer systems can be user configurable and swappable. The periphery apparatuses may include a network card, a blue tooth card or a webcam card . . . etc. Each of the periphery apparatuses can use a PCI port or a USB port to transmit signal to a computer system. But the user might insert a periphery apparatus that is non-qualified or non-certified or might modify the setting of the periphery apparatus. However, the non-qualified or non-certified periphery apparatus might cause the computer system damage or unpredictable error. Therefore, it will cause high repair fee or time for the computer system.

In prior art technology, a monitor apparatus for monitoring periphery apparatuses for the PCI interface is developed. However, with the more and more periphery apparatuses using the PCI port to transmit signal, the PCI interface might be overload. Therefore, now many periphery apparatuses use USB port for data transmission. But there are no monitor apparatus or method to monitor the USB device in prior art technology.

It is therefore desirable to provide a monitor apparatus and a monitor method to solve the aforementioned problems.

### SUMMARY OF THE INVENTION

A main objective of the present invention is to provide a monitor apparatus for monitoring a USB port of a computer system.

Another objective of the present invention is to provide a monitor method.

In order to achieve the above mentioned objectives, the present invention provides a monitor apparatus used to monitor an USB port of a computer. The monitor apparatus comprises an input/output control unit, a basic input/output system code storage unit and a database. The basic input/output system code storage unit is electrically connected to the input/output control unit and used for storing a basic input/output system code. The database is used for storing an identification list. When the input/output control unit is connected to the USB device via the USB port, the input/output control unit is used for executing the basic input/output system code to read the identification of the USB device and compare the identification with the identification list to check whether the identification is a certified identification.

The monitor method of the present invention comprises following steps: executing the basic input/output system code; determining whether the USB port connects with a USB device or not; if the USB port connects with a USB device, reading out an identification of the USB device; determining whether the identification is a certified identification or not; and executing a correspondingly process if the identification is not a certified identification.

Other objects, advantages, and novel features of the invention will become more apparent from the following detailed description when taken in conjunction with the accompanying drawings.

### BRIEF DESCRIPTION OF THE DRAWINGS

FIG. 1 is a system block drawing of a computer system and a monitor apparatus according to the present invention.

FIG. 2 is a flowchart of a monitor method of the present invention.

FIG. 3 is a schematic drawing of an identification list according to the present invention.

### DETAILED DESCRIPTION OF THE PREFERRED EMBODIMENT

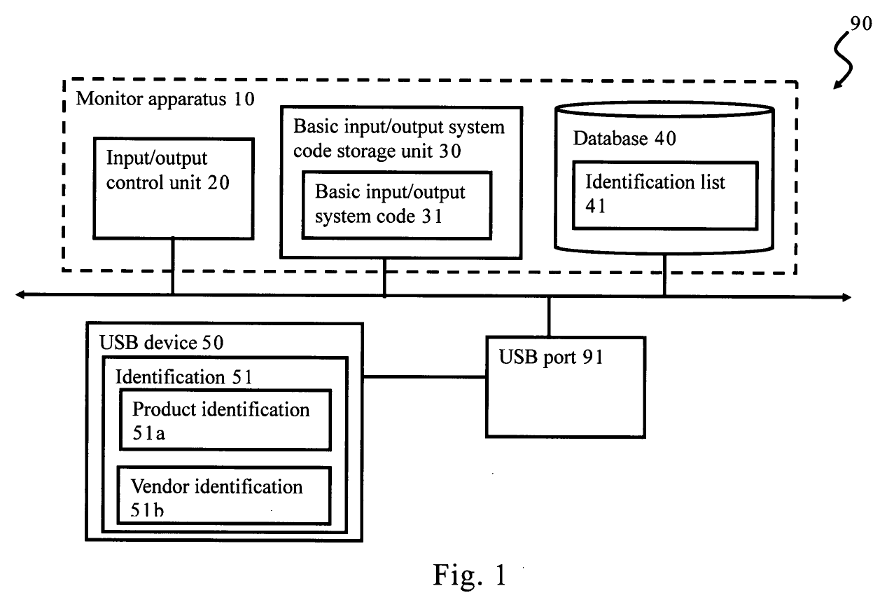

Please refer to FIG. 1. FIG. 1 is a system block drawing of a computer system and a monitor apparatus according to the present invention.

A monitor apparatus 10 is disposed in the computer system 90, and the computer system 90 has a USB port 91. In this embodiment, the monitor apparatus 10 can be a module and optionally disposed on a motherboard (not shown) of the computer system 90. The USB port 91 is a connecting port which transmitting data via an USB, for example, a slot of an USB device. The USB port 91 can be used for installing a corresponding USB device 50. In one embodiment, the computer system 90 can be a notebook computer or other equivalent device (such as desktop computers).

The monitor apparatus 10 comprises an input/output control unit 20, a BIOS (basic input/output system) code storage unit 30 and a database 40, and all of the above-mentioned elements are electrically connected with each other. The input/output control unit 20 can be a south bridge chip of the computer system 90 or other element. The basic input/output system code storage unit 30 can be a flash memory and is used for storing the basic input/output system code 31, but it can be other equivalent elements. The basic input/output system code 31 includes the necessary procedure for the computer system 90 to perform a POST (power on self test), which has a monitor procedure for the USB port 91. The database 40 is used for storing an identification list 41. An identification list 41 includes certified identifications which are used for comparing with the identification 51 of the USB device 50.

The USB device 50 can be a network card, a blue tooth transmission card or other device, which uses the USB for data transmission. The USB device 50 has a preset specific identification 51, and the identification 51 comprises a product identification (product ID) 51a and a vendor identification (vendor ID) 51b or other options. When the computer system 90 is turned on, the input/output control unit 20 executes the monitor procedure of the basic input/output system code 31 to monitor the computer system 90. The input/output control unit 20 reads the identification 51 of the USB device 50 and checks the identification list 41 to ensure whether the identification 51 is a certified identification. The monitor procedure will be explained in detail in following description.

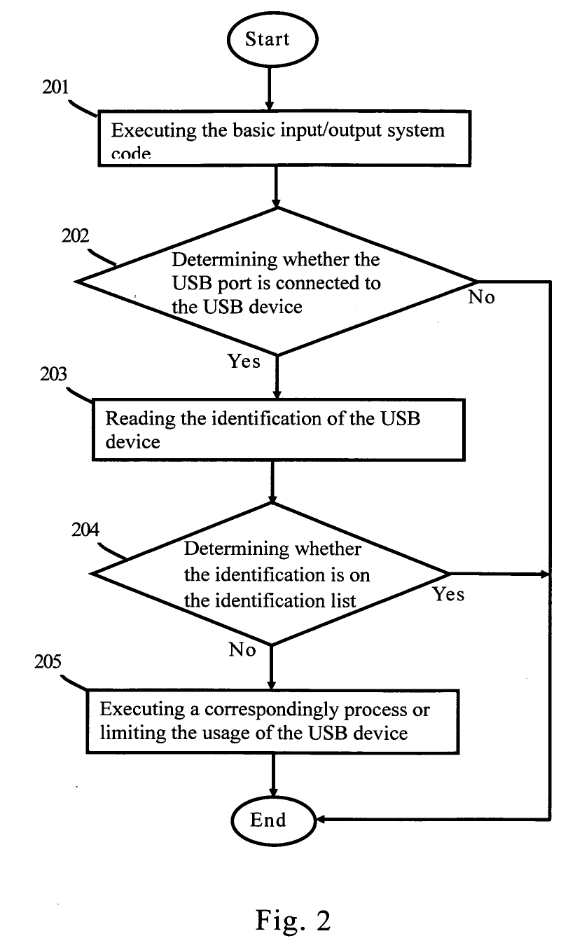

Please refer to FIG. 2. FIG. 2 is a flowchart of a monitor method of the present invention. Even though following description explains the monitor method of the present invention with a monitor apparatus 10, the monitor method of the present invention can be carried out by other device other than the monitor apparatus 10.

First, step 201: executing the basic input/output system code.

When the computer system 90 is turned on, the basic input/output system code 31 is executed to perform the POST to check the hardware status for the computer system 90.

Step 202: determining whether the USB port is connected to the USB device.

Meanwhile, the input/output control unit 20 checks whether the USB port 91 is connected to the USB device 50, in the other words, whether the USB device 50 is inserted into the USB slot. Since the address of the USB port 91 is fixed, the input/output control unit 20 sends a signal to the address of the USB port 91 to ensure whether the USB port 91 is connected to the USB device 50. If the USB port 91 is connected to the USB device 50, step 203 will be performed. If the USB port 91 is not connected to the USB device 50, the input/output control unit 20 ends the monitor procedure for the USB port 91.

Step 203: reading the identification of the USB device.

Afterward, the input/output control unit 20 uses the basic input/output system code 31 to read the identification 51 of the USB device 50. In one embodiment, the input/output control unit 20 reads the product identification 51a and the vendor identification 51b of the USB device 50.

Step 204: determining whether the identification is on the identification list.

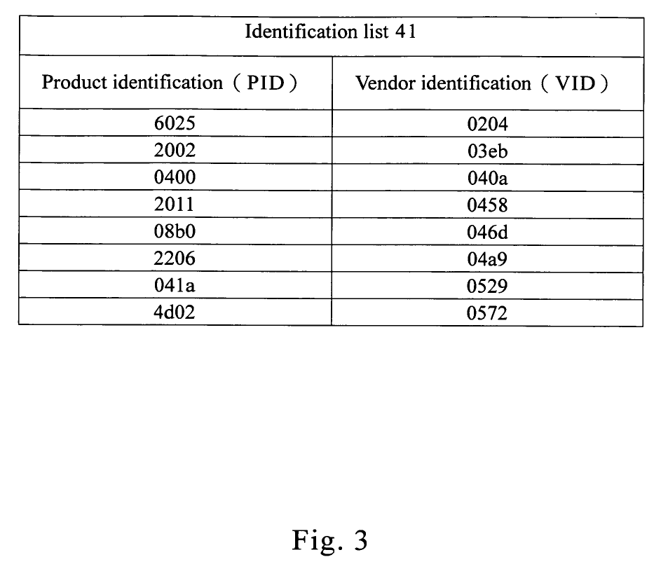

Please refer to FIG. 3. FIG. 3 is a schematic drawing of an identification list according to the present invention. When the product identification 51a and the vendor identification 51b are obtained, the input/output control unit 20 inquires the identification list 41 stored in the database 40 to determine whether the product identification 51a and the vendor identification 51b are certified identifications on the identification list 41. For example, if the product identification 51a obtained in step 203 is 0400 and the vendor identification 51b obtained in step 203 is 040a; then by comparing them with the certified identification on the identification list 41, it can be found that the product identification 51a and the vendor identification 51b are both included in certified identification on the identification list 41. Therefore, the USB device 50 is a certified device, and the monitor procedure can be ended. If the product identification 51a and the vendor identification 51b are not included on the identification list 41, step 205 will be performed.

However, the certified identifications on the identification list 41 shown in FIG. 3 are just examples; the identifications shown in FIG. 3 should not limit the present invention.

Step 205: executing a correspondingly process or limiting the usage of the USB device.

If the product identification 51a or the vendor identification 51b is not included in certified identifications on the identification list 41, it indicates the USB device 50 is not a qualified or certified device. Therefore, in order to avoid this USB device 50 cause any damage to the computer system 90, the input/output control unit 20 immediately executes the basic input/output system code 31 to perform the corresponding process. The corresponding process might be able to stop the booting process of the computer system 90 or limit the usage of the USB device 50. Furthermore, the USB device 50 is limited by disabling some functionalities of the USB device 50 or totally blocking the USB device 50. In addition, an error message can be shown on the display screen of the computer system 90 to inform the user. However, the present invention can have other design than the above-mentioned process.

Moreover, the monitor method of the present invention is not limited as the above mentioned description, and the step sequence of the monitor method can also be changed.

With the monitor method of the present invention, it can avoid a non-qualified or non-certified USB device 50 to cause the computer system 90 damaging.

Although the present invention has been explained in relation to its preferred embodiment, it is to be understood that many other possible modifications and variations can be made without departing from the spirit and scope of the invention as hereinafter claimed.

What is claimed is:

1. A monitor apparatus comprising:
an input/output control unit; and
a BIOS (basic input/output system) code storage unit electrically connected to the input/output control unit, for storing a basic input/output system code; wherein the input/output control unit is inserted in a USB port to connect to a USB device, and is used for executing the basic input/output system code to read an identification of the USB device and checking whether the identification is a certified identification.

2. The monitor apparatus as claimed in claim 1, wherein the identification comprises a product identification or a vendor identification.

3. The monitor apparatus as claimed in claim 1 further comprises a database, for storing an identification list, and the input/output control unit uses the identification list to check whether the identification is a certified identification.

4. The monitor apparatus as claimed in claim 1, wherein the input/output control unit is a south bridge chip.

5. A monitor method comprising:
executing a basic input/output system code of a computer system;
determining whether the USB port connects with a USB device;
if the USB port connects with a USB device, reading out an identification of the USB device;
determining whether the identification is a certified identification; and
executing a correspondingly process if the identification is not a certified identification.

6. The monitor method as claimed in claim 5, wherein the last step further comprises: stopping a booting procedure of the computer system.

7. The monitor method as claimed in claim 5, wherein the last step further comprises: displaying an error message.

8. The monitor method as claimed in claim 5, wherein the last step further comprises: limiting the usage of the USB device.

9. The monitor method as claimed in claim 5, wherein the step of determining whether the identification is a certified identification further comprises: determining whether the identification is included in an identification list.

10. The monitor method as claimed in claim 5, wherein the identification comprises a product identification or a vendor identification.

11. A computer system comprising:
a USB port for connecting a USB device; and
a monitor apparatus electrically connected to the USB port; the monitor apparatus comprising:
an input/output control unit; and
a basic input/output system code storage unit electrically connected to the input/output control unit, for storing a basic input/output system code;
wherein the input/output control unit is inserted in the USB port to connect to the USB device, the input/output control unit is used for executing the basic input/output system code to read the identification of the USB device and check whether the identification is a certified identification.

12. The computer system as claimed in claim 11, wherein the identification comprises a product identification or a vendor identification.

13. The computer system as claimed in claim 11, wherein the monitor apparatus further comprises a database for storing a identification list, and the input/output control unit uses the identification to check whether the identification is a certified identification.

14. The computer system as claimed in claim 11, wherein the input/output control unit is a south bridge chip.
